(19) United States
(12) Patent Application Publication
(10) Pub. No.: US 2023/0010112 A1
(43) Pub. Date: Jan. 12, 2023

(54) PERFORMANCE METRICS OF DOMAINS

(71) Applicant: Hewlett-Packard Development Company, L.P., Spring, TX (US)

(72) Inventors: Lorri L. Jefferson, Spring, TX (US); Robert Andrew Ray, Orlando, FL (US); Gaurav Roy, Spring, TX (US); Amit Kumar Singh, Spring, TX (US)

(73) Assignee: Hewlett-Packard Development Company, L.P., Spring, TX (US)

(21) Appl. No.: 17/785,198

(22) PCT Filed: Dec. 16, 2019
(86) PCT No.: PCT/US2019/066594

§ 371 Date: Jun. 14, 2022

(51) Int. Cl. H04L 43/065; H04L 43/0817; H04L 43/0864

(52) U.S. Cl. CPC H04L 43/065; H04L 43/0817; H04L 43/0864

(57) ABSTRACT

In some examples, a non-transitory computer-readable medium stores machine-readable instructions which, when executed by a processor, cause the processor to: collect operational data of an enterprise; identify a domain of the operational data; determine a performance metric of the domain; and generate a report based on the performance metric.

### BACKGROUND

Operational data of a computing device may include data about hardware, applications, and their daily operations. Operational data provides useful information for determining performance metrics for the computing device as well as for a network, network components, and applications which the computing device may access via the network.

### BRIEF DESCRIPTION OF THE DRAWINGS

Various examples will be described below referring to the following figures:

FIG. 1 depicts a schematic diagram of a system in accordance with various examples;

FIG. 2 depicts a schematic diagram of a system in accordance with various examples;

FIG. 3 depicts a schematic diagram of a processing environment of a system in accordance with various examples;

FIG. 4 depicts a schematic diagram of a processing environment of a system in accordance with various examples;

FIG. 5 depicts a schematic diagram of a system in accordance with various examples;

FIG. 6 depicts a schematic diagram of a system in accordance with various examples;

FIG. 7 depicts a flow diagram of a method in accordance with various examples;

FIG. 8 depicts a flow diagram of a method in accordance with various examples; and

FIG. 9 depicts a flow diagram of a method in accordance with various examples.

### DETAILED DESCRIPTION

As explained above, operational data of a computing device (e.g., laptop, notebook, tablet, smartphone, mobile device, or some other electronic device with an ability to capture data about operations of the device) may provide information that is useful in determining performance metrics of the computing device. The performance metrics of the computing device may include performance metrics of a network, network components, and applications (e.g., machine-readable instructions) which the computing device may access via the network (e.g., Internet-based applications, Web-based applications). In some cases, the computing device belongs to an enterprise (e.g., business, company). The computing device is connected to other computing devices of the enterprise via a network having network components. The enterprise utilizes applications accessible via domains (e.g., Internet Protocol (IP) addresses) of the network (e.g., intranet, Internet). Operational data of the computing device may include information on interactions between the computing device and the network, the network components, and the applications accessible via domains of the network. For example, the operational data may include bandwidth (e.g., maximum rate at which information can be transferred), throughput (e.g., actual rate at which information is transferred), latency (e.g., delay between one device sending a request and another device receiving and acknowledging the request), and error rate (e.g., ratio of corrupted data received and total data sent) measurements captured during interactions between the computing device and the network, the network components, and the applications accessible via domains of the network.

Operational data may include information on hundreds or thousands of daily operations of the computing device. For example, interactions between the computing device and the network, the network components, and the applications accessible via domains of the network may generate multiple measurements per minute. During an eight-hour work day, the interactions could account for over five hundred instances of operational data or more. Sorting through the operational data to determine what information may be associated with performance metrics of the interactions of the computing device with a network, network components, and/or applications accessible via domains of the network may be difficult due to the quantity of information.

This disclosure describes various examples of collecting operational data of an enterprise and multiple computing devices of the enterprise. The operational data is categorized by a domain utilized by the enterprise to access an application. The operational data corresponding to the domain is analyzed to determine a performance metric associated with the domain. The performance metrics may include an average domain network latency (e.g., the average network latency across all domains utilized by the enterprise), an average application network latency (e.g., the average network latency of an application accessible via a domain), an average domain network latency per location (e.g., the average network latency per domain per location of an enterprise), and an average application performance (e.g., the average performance of an application accessible via a domain compared to the average performance of all applications accessible via domains), for example. Based on the performance metric, a report is generated. The report may include the performance metric, a comparison to performance metrics of other enterprises accessing the domain utilized in determining the performance metric, and/or a recommendation to improve the performance metric.

In one example in accordance with the present disclosure, a non-transitory computer-readable medium stores machine-readable instructions which, when executed by a processor, cause the processor to: collect operational data of an enterprise; identify a domain of the operational data; determine a performance metric of the domain; and generate a report based on the performance metric.

In another example in accordance with the present disclosure, a system comprises: a network interface; a storage device comprising machine-readable instructions; and a processor coupled to the network interface, the processor to access the storage device. Execution of the machine-readable instructions causes the processor to: collect operational data of an enterprise; collect operational data of multiple computing devices of the enterprise; identify a domain of the operational data of the enterprise; categorize, by the domain, the operational data of the multiple computing devices; evaluate the operational data corresponding to the domain; and generate a report based on the evaluation.

In yet another example in accordance with the present disclosure, a method comprises: collecting operational data of multiple computing devices; identifying a domain of the operational data; aggregating the operational data corresponding to the domain; determining a domain network latency based on the operational data; and generating a report, wherein the report includes a recommendation to improve domain performance based on the domain network latency.

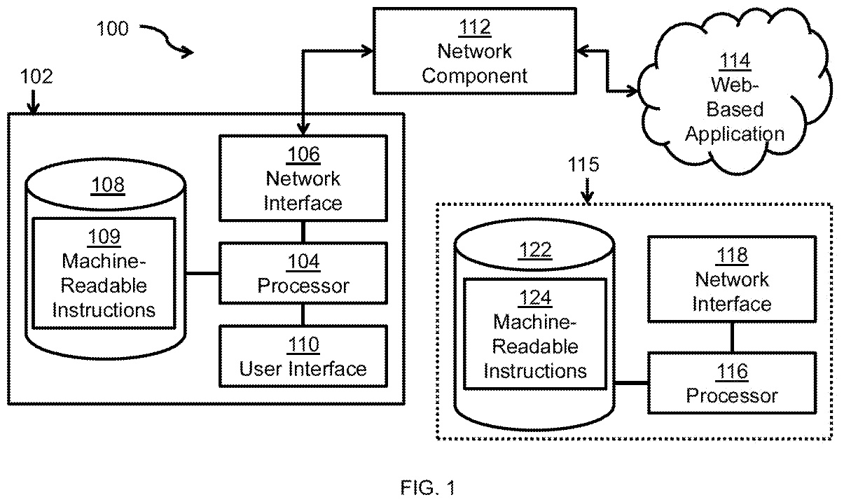

FIG. 1 depicts a schematic diagram of a system 100, in accordance with various examples. The system 100 may be a network of an enterprise, for example. The system 100 comprises a Web-based application 114, a computing device 102, and a network component 112 coupled to the Web-based application 114 and the computing device 102. The computing device 102 may be a laptop, notebook, tablet, smartphone, mobile device, or some other electronic device with an ability to access the Internet, for example. The computing device 102 comprises a storage device 108, a network interface 106, a user interface 110, and a processor 104 coupled to the network interface 106, the storage device 108, and the user interface 110. The network component 112 may be a router, a switch, a cable, a modem, or a hub, for example. In some examples, the Web-based application 114 is stored on a remotely-managed computing device 115 (e.g., server, central server, edge server, or some other suitable computing device) comprising a network interface 118, a storage device 122, and a processor 116 coupled to the network interface 118 and the storage device 122, for example. The storage device 122 may store machine-readable instructions 124, which, when executed, cause the processor 116 to perform some or all of the actions attributed herein to the Web-based application 114. The Web-based application 114 is an example of an application accessible via a domain of a network. In some examples, the domain utilized to access the Web-based application 114 may also be utilized by another Web-based application. Each Web-based application 114 utilizing the domain may have an endpoint, or sub-domain. In various examples, the storage device 108 may store machine-readable instructions 109, which, when executed, cause the processor 104 to perform some or all of the actions attributed herein to the processor 104.

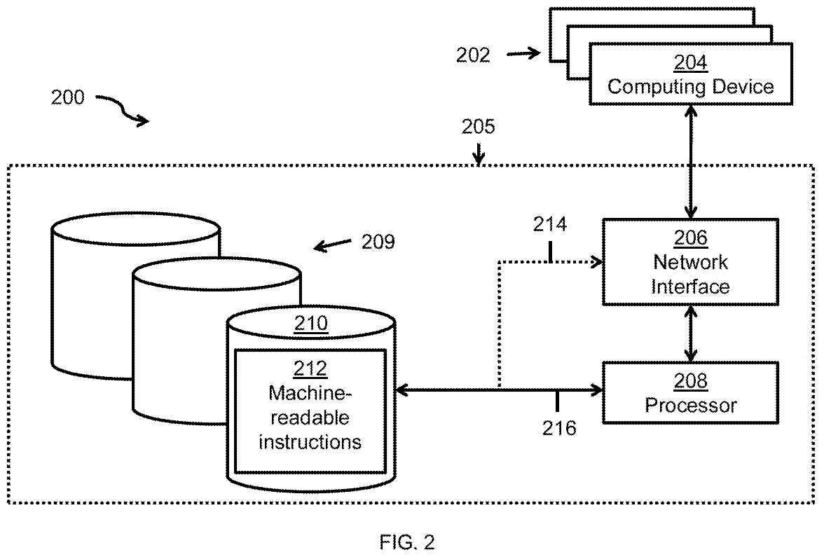

In operation, a user may interact with a domain hosting the Web-based application 114 via the user interface 110. The storage device 108 may comprise machine-readable instructions 109. The machine-readable instructions 109, when executed, may cause the processor 104 to interpret the user interaction as a request to interact with the Web-based application 114. The processor 104 may create a data packet encapsulating the interaction request. The processor 104 may transmit the data packet via the network interface 106 to the network component 112. The network component 112 may pass the data packet on to the Web-based application 114. The Web-based application 114 may receive the data packet and perform the interaction. As discussed above, the interaction between the user and the Web-based application 114 may generate multiple measurements per minute during the transmission process. The operational data may be stored on the storage device 108 or on a remotely-managed storage device, as discussed below with respect to FIG. 2.

In some examples, the processor 104 may utilize the measurements to generate operational data corresponding to the domain of the Web-based application 114. The operational data corresponding to the domain may include an application; a packet type (e.g., bulk, small); an average packet for the packet type; a network latency of the domain, and, if applicable, a network latency of an endpoint; and a throughput of the domain. The network latency of the domain is the response time for a packet to travel from the computing device to the domain and back to the computing device. The throughput of the domain is the size of data sent and received divided by the unit of time for the data to travel from the computing device to the domain. The application may include an identifier, a vendor of the application, a name of the application, a list of computing devices with access rights, and a name of an enterprise with access rights, for example. The network latency of the domain and the network latency of an endpoint each may be considered a domain measurement, or performance data corresponding to a domain. Bandwidth, throughput, and error rate may also be considered domain measurements. In one example, the processor 104 may calculate a domain measurement when a connection to the network component 112 is lost or established. In another example, the processor 104 may calculate a domain measurement daily. The operational data corresponding to the domain may be stored on the storage device 108 or on a remotely-managed storage device, as discussed below with respect to FIG. 2.

In various examples, the computing device 102 is a computing device of multiple computing devices of an enterprise. In some examples, the network component 112 is a network component of multiple network components of a network. In other examples, an enterprise may utilize multiple networks, each network having multiple network components. A computing device 102 may have access to one of the multiple networks or a plurality of the multiple networks. Operational data of the computing device 102 may include information that identifies the enterprise, identifies the computing device, identifies the network, identifies the network components, and identifies the Web-based application 114. In various examples, the identifying information may be stored separately (e.g., in a separate data structure) from operational data collected during daily operations. The identifying information may be stored on the storage device 108 or on a remotely-managed storage device, as discussed below with respect to FIG. 2.

FIG. 2 depicts a schematic diagram of a system 200, in accordance with various examples. The system 200 comprises computing devices 202 and a processing environment 205 coupled to the computing devices 202. A computing device 204 of the computing devices 202 may be a laptop, notebook, tablet, smartphone, mobile device, or some other electronic device with an ability to capture data about operations of the device, for example. In some examples, the computing device 204 may be the computing device 102 (FIG. 1). The processing environment 205 may be a computing device (e.g., server, central server, edge server, or some other suitable computing device) or a network of computing devices (e.g., local area network (LAN), wide area network (WAN), virtual private network (VPN), client/server network, Internet (e.g., cloud), or any other suitable system for sharing processing and memory resources).

The processing environment 205 comprises a network interface 206, a processor 208 coupled to the network interface 206, and storage devices 209. The processor 208 may be a microprocessor, a microcomputer, a microcontroller, or other suitable processor or controller, for example. In some examples, such as when the storage devices 209 are remotely-managed storage devices (e.g., enterprise cloud, public cloud, data center, server, or some other suitable storage device), the processor 208 may be communicatively coupled to the storage devices 209 via a path 214 coupling the network interface 206 and the storage devices 209. In other examples, such as when the processor 208 and the storage devices 209 are located on a computing device, the storage devices 209 may be coupled via a path 216 to the processor 208. A storage device 210 of the storage devices 209 may be a hard drive, solid state drive (SSD), flash memory, random access memory (RAM), or other suitable memory, for example. The storage device 210 may store machine-readable instructions 212, which, when executed, cause the processor 208 to perform some or all of the actions attributed herein to the processor 208.

In various examples, the computing device 204 may belong to one enterprise, while another computing device of the computing devices 202 may belong to another enterprise. In some examples, as discussed above with respect to FIG. 1, the computing devices 202 are owned by one enterprise. In some examples, an enterprise to which the computing devices 202 belong has granted an enterprise owning the processing environment 205 access rights to the computing devices 202. In other examples, an enterprise owning the processing environment 205 has granted an enterprise to which the computing devices 202 belong access rights to the storage devices 209. The enterprise to which the computing devices 202 belong may grant the enterprise owning the processing environment 205 access rights to data of the computing devices 202 stored on the storage devices 209. For example, the enterprise to which the computing devices 202 belong may have the ability to upload data for storage on the storage devices 209. The processing environment 205 may then access the data to identify data of interest (e.g., operational data) and analyze the data (e.g., performance metrics).

In some examples, by granting access rights across multiple enterprises, an enterprise associated with the processing environment 205 may gather more operational data relating to an application accessible via a domain of a network. Having more data regarding the application may enable the enterprise to better analyze performance metrics for the computing device 204 and a network, network components, or application with which the computing device 204 accesses via a domain of the network. For example, if a user of the computing device 204 attempts to watch a video on a Web-based application (e.g., 114), the video may skip, freeze, or cause the Web-based application to exit without warning. In some instances, the failure could be due to packet loss. However, the packet loss could occur on the computing device 204, a network component (e.g., 112) of the network, or the Web-based application. One failure might not provide enough information to diagnose the failure. When the processor 208 has access to multiple computing devices 202 of a system of a first enterprise (e.g., 100) utilizing the system 200, and the multiple computing devices 202 each experience the failure, then the processor 208 may be better able to determine the cause of the failure. If the processor 208 has access to multiple computing devices 202 of a system of a second enterprise utilizing the system 200, then the processor 208 may be able to compare the performance of the Web-based application on a network of the first enterprise to the performance of the Web-based application on a network of the second enterprise. Based on the comparison, the processor 208 may provide a recommendation on how to improve performance on the network of the first enterprise, the network of the second enterprise, or the network of both the first and the second enterprise.

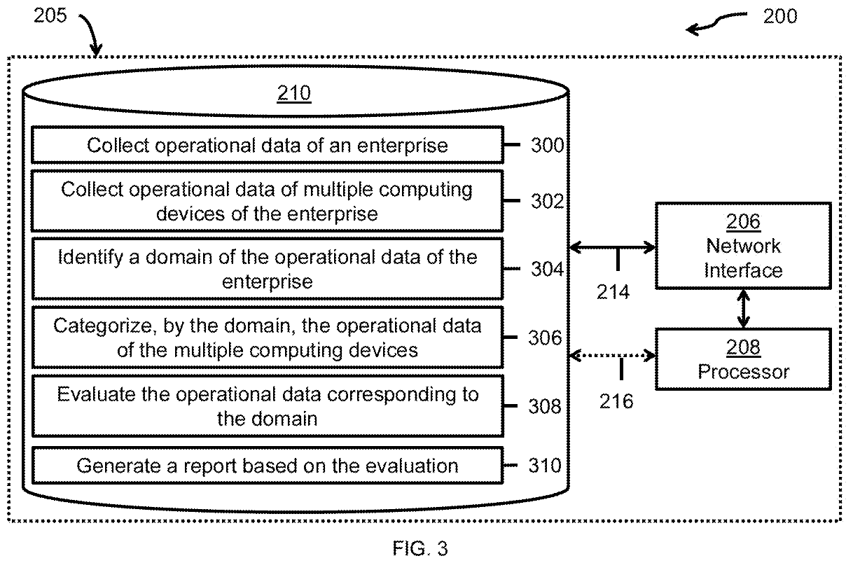

FIG. 3 depicts a schematic diagram of the processing environment 205 of the system 200, in accordance with various examples. As discussed above with respect to FIG. 2, the processing environment 205 may be a computing device or may be a network of computing devices. In one example, the processing environment 205 includes a computing device comprising the network interface 206, the storage device 210, and the processor 208. The processor 208 is coupled to the storage device 210 via the path 216 and to the network interface 206. In another example, the processing environment 205 includes a network of computing devices. A computing device 204 comprises the network interface 206 coupled to the processor 208. The processor 208 communicatively couples to the remotely-managed storage device 210 via the path 214, which couples the remotely-managed storage device 210 to the network interface 206 of the computing device 204. In various examples, the storage device 210 may store machine-readable instructions 212, which, when executed, cause the processor 208 to perform some or all of the actions attributed herein to the processor 208.

In some examples, the storage device 210 comprises machine-readable instructions 300, 302, 304, 306, 308, and 310. The machine-readable instructions 300, 302, 304, 306, 308, 310 may be machine-readable instructions 212 (FIG. 2), for example. The machine-readable instructions 300, 302, 304, 306, 308, 310 may be machine-readable instructions for execution by the processor 208. The machine-readable instructions 300, 302, 304, 306, 308, 310 may cause the processor 208 to evaluate the operational data corresponding to a domain of an enterprise and multiple computing devices (e.g., 202) of the enterprise and generate a report based on the evaluation. Execution of machine-readable instruction 300 may cause the processor 208 to collect operational data of an enterprise. Execution of machine-readable instruction 302 may cause the processor 208 to collect operational data of multiple computing devices of the enterprise. Execution of machine-readable instruction 304 may cause the processor 208 to identify a domain of the operational data of the enterprise. Execution of machine-readable instruction 306 may cause the processor 208 to categorize, by the domain, the operational data of the multiple computing devices. Execution of machine-readable instruction 308 may cause the processor 208 to evaluate the operational data corresponding to the domain. Execution of machine-readable instruction 310 may cause the processor 208 to generate a report based on the evaluation.

In some examples, operational data comprising identifying information of the enterprise may be collected once or when the identifying information is updated. The identifying information of the enterprise may include a name, an email, a phone number, an identifier, an office address, a list of locations of the enterprise, a list of computing devices belonging to the enterprise and an identifier for each computing device, a list of intranet domains (e.g., owned by the enterprise), a list of applications utilized by the enterprise, a list of domains (e.g., Internet), and a list of applications per Internet domain, for example. The list of locations of the enterprise may include distinct office locations, distinct networks of an office location, and virtual private networks (VPNs), for example. A domain on the list of intranet domains may include a list of applications accessible via the intranet domain, for example. An application on the list of applications may include an identifier, a vendor of the application, a name of the application, a list of computing devices with access rights, and a name of an enterprise with access rights, for example. A domain of the list of applications per Internet domain may include a list of applications accessible per Internet domain, for example. In one example, if an application is removed from the list of applications accessible per intranet domain, a processor of a computing device of the enterprise may set a flag to indicate a change in the identifying information. When the processor 208 next collects operational data of the enterprise, the processor 208 may evaluate the flag to determine if any of the identifying information has changed. In response to an evaluation indicating the identifying information has changed, the processor 208 may collect all of the identifying information, a subset of the identifying information, or the changed identifying information alone.

In other examples, operational data comprising identifying information of the multiple computing devices 202 may be collected once or when the identifying information is updated. The identifying information of a computing device may include an identifier, an enterprise, processor information (e.g., identifier, specifications), memory information (e.g., identifier, specifications, type (e.g., RAM)), and disk information (e.g., identifier, specifications), for example. In one example, if the memory of the computing device 204 is upgraded, then the processor 208 of the computing device 204 may update the memory information of the identifying information. The processor 208 of the computing device 204 may set a flag indicating a change in the identifying information. When the processor 208 collects operational data of multiple computing devices of the enterprise, the processor 208 may evaluate a flag of each computing device to determine if a change in the identifying information occurred. If the flag of a computing device (e.g., 204) indicates a change has occurred, then the processor 208 may collect all of the identifying information for the computing device or may collect the changed identifying information alone.

In yet other examples, the processor 208 may collect operational data of the multiple computing devices 202 daily. Operational data that may be captured daily includes operational data corresponding to a domain, as discussed above with respect to FIG. 1; device location; and a domain history (e.g., a history of domains utilized by a user of a computing device). Device location may include an identifier, an intranet domain, and a location. For example, the processor 208 may collect the operational data at the end of regular business hours for the enterprise. In various examples, the processor 208 may collect operational data on reboot of a computing device of the multiple computing devices 202. For example, a processor of the computing device 204 may reboot the computing device 204. After rebooting, the processor of the computing device 204 may store operational data of the computing device 204 to storage devices 209. The processor of the computing device 204 may notify the processor 208 that new operational data is available. The processor 208 may collect the operational data upon notification. In some examples, the processor 208 may collect operational data after a network connection is created. For example, if a connection to a wireless router is lost and then re-established, the processor of the computing device 204 may store operational data of the computing device 204 to a local storage device. The processor of the computing device 204 may notify the processor 208 that new operational data is available. The processor 208 may access the local storage device of the computing device 204 and collect the operational data. Reducing the number of times the processor 208 collects operational data reduces central processing unit (CPU) and memory utilization.

In various examples, after collecting operational data of the enterprise and the multiple computing devices of the enterprise, the processor 208 assimilates and cleans the operational data. Assimilating and cleaning the operational data may include removing improper values (e.g., data outside actual possible parameters of a component), and removing partial data (e.g., data with collection errors). The processor 208 may search the assimilated and cleaned operational data for operational data corresponding to a domain of the enterprise. In some examples, the assimilated and cleaned operational data may include noise (e.g., data not related to a domain or that is redundant to other data). The processor 208 may remove the noisy data so that the remaining operational data comprises operational information related to a domain.

In some examples, the processor 208 may categorize, by domain, the operational data of the multiple computing devices by aggregating operational data related to a domain into a data structure (e.g., lookup table, database). The data structure may be stored on storage device 210 or another storage device of storage devices 209, for example. Each domain of the domains of the enterprise may have a stored data structure comprising aggregated operational data corresponding to a domain.

In various examples, the processor 208 evaluates the operational data corresponding to a domain utilizing differential privacy processing. Differential privacy processing enables the system 200 to process the information of multiple enterprises while protecting the privacy of the individual enterprises. The processor 208 assigns individual enterprises identifiers to protect the privacy of each enterprise.

In some examples, the processor 208 evaluates operational data of each domain to determine performance metrics of each domain of a list of domains for each enterprise for which system 200 has access rights. The processor 208 may evaluate operational data corresponding to a domain on a routine basis (e.g., daily, weekly, monthly). Before evaluating operational data corresponding to a domain, the processor 208 may aggregate operational data related to an enterprise into a data structure. As explained above, the performance metrics may include an average domain network latency, an average application network latency, an average domain network latency per location, and an average application performance per enterprise, for example.

In various examples, the processor 208 calculates an average domain network latency by averaging the average network latency per domain of all operational data of an enterprise. In some examples, the processor 208 calculates the average application network latency by averaging a weighted mean of all domains of an enterprise. The processor 208 may calculate an average application network latency per packet type. The weight corresponding to a domain may be stored on the storage device 210 or on another storage device of the storage devices 209. In various examples, the weight corresponding to a domain may be affected by a number of applications accessible via the domain. In other examples, the weight corresponding to a domain may change based on new data sets. For example, the processor 208 may adjust the weight for one domain after determining the domain is accessed more often than the previous week. In one example, the processor 208 may adjust the weights of other domains such that the sum of the weights of all the domains remains the same. In another example, the processor 208 may determine a new sum of weights of the domains to utilize in the calculation of the weighted mean of all domains. The results of the calculations for the average application network latency may be stored in a data structure. The data structure may be stored on the storage device 210 or may be stored on another storage device of the storage devices 209, for example.

In various examples, the processor 208 may calculate the average domain network latency per location of an enterprise after aggregating operational data related to a location into a data structure. The processor 208 calculates the average domain network latency per location by averaging the average network latency of operational data of a location. The processor 208 calculates the average domain network latency per location for each location. The results of the calculations for the average domain network latency per location may be stored in a data structure. The data structure may be stored on the storage device 210 or may be stored on another storage device of the storage devices 209, for example.

In some examples, the average application performance per enterprise may be calculated after aggregating operational data corresponding to a domain of an enterprise by an application of the domain. The processor 208 calculates the average application performance per enterprise by averaging the average network latency of operational data of an application. In various examples, the processor 208 calculates an average application performance per enterprise for each packet type. The results of the calculations for the average application performance may be stored in a data structure. The data structure may be stored on the storage device 210 or may be stored on another storage device of the storage devices 209, for example.

In various examples, the processor 208 generates a report based on the performance metrics. The report may cover performance metrics corresponding to a specified period (e.g., day, week, month). The report may include an average domain network latency, a list of the average application network latency, a list of average domain network latency per location, and/or an average application performance. The processor 208 may publish the report to a peripheral device of the system 200. The peripheral device may be a printer of the system 200 or a display of a computing device (e.g., 204) of the system 200, for example. In some examples, the list of average domain network latency per location and the list of the average application network latency may be categorized (e.g., alphabetically by name, best-to-worst, worst-to-best).

In some examples, the processor 208 generates a report that includes a comparison to performance metrics across all enterprises, or a subset of enterprises (e.g., companies within an industry), for which the system 200 has access rights for operational data. In one example, the average application performance metric may include a comparison to the average application performance across all the enterprises for which the system 200 has access rights for operational data. The comparison may be presented as a performance spectrum with the average application performance metric presented on the performance spectrum. For example, if the average application performance metric equals or exceeds the average application performance across all the enterprises, then the average application performance metric for the enterprise is placed on the higher end of the performance spectrum (e.g., to indicate the performance metric is above average).

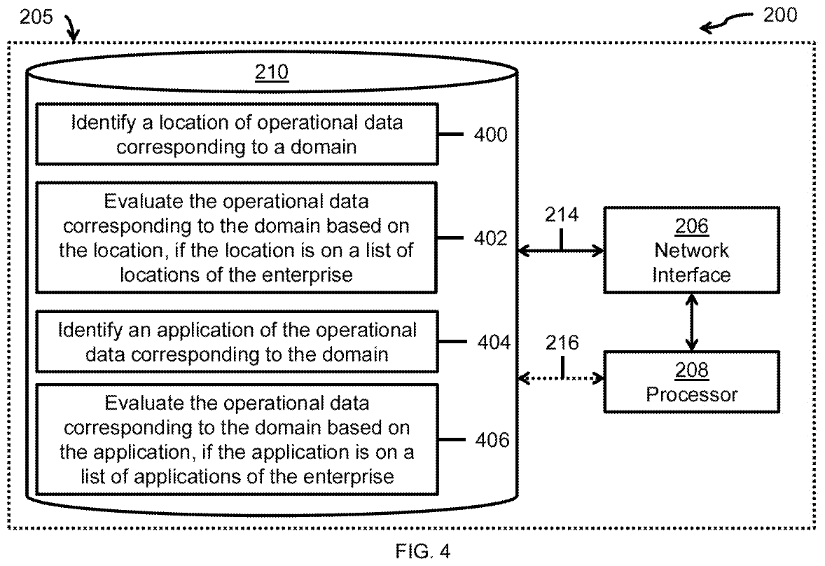

FIG. 4 depicts a schematic diagram of the processing environment 205 of the system 200, in accordance with various examples. As discussed above with respect to FIG. 2 and FIG. 3, the processing environment 205 may be a computing device comprising the network interface 206, the storage device 210, and the processor 208. The processor 208 is coupled to the storage device 210 via the path 216 and to the network interface 206. In other examples, the processing environment 205 may be a network of computing devices with a computing device of the network comprising the processor 208 coupled to the network interface 206. The processor 208 is communicatively coupled to the remotely-managed storage device 210 via the path 214 coupling the remotely-managed storage device 210 and the network interface 206. In various examples, the storage device 210 may store machine-readable instructions, which, when executed, cause the processor 208 to perform some or all of the actions attributed herein to the processor 208.

In some examples, the storage device 210 comprises machine-readable instructions 400, 402, 404, and 406. The machine-readable instructions 400, 402, 404, 406 may be machine-readable instructions 212, for example. The machine-readable instructions 400, 402, 404, 406 may be machine-readable instructions for execution by the processor 208. Execution of the machine-readable instructions 400, 402, 404, 406 may cause the processor 208 to evaluate, based on a location or an application, the operational data corresponding to a domain. Execution of machine-readable instruction 400 may cause the processor 208 to identify a location of operational data corresponding to a domain. Execution of machine-readable instruction 402 may cause the processor 208 to evaluate the operational data corresponding to the domain based on the location, if the location is on the list of locations of the enterprise. Execution of machine-readable instruction 404 may cause the processor 208 to identify an application of the operational data corresponding to the domain. Execution of machine-readable instruction 406 may cause the processor 208 to evaluate the operational data corresponding to the domain based on the application, if the application is on a list of applications of the enterprise.

As discussed above with respect to FIG. 3, operational data corresponding to a domain may include a device location. The device location may include an identifier, an intranet domain, and a location. In some examples, the processor 208 may identify a location of operational data corresponding to a domain by searching for one of the identifier, the intranet domain, or the location of the device location stored in the operational data. As discussed above with respect to FIG. 3, the list of locations of the enterprise may include distinct office locations, distinct networks of an office location, and virtual private networks (VPNs). Each distinct office location, distinct network of an office location, and VPN may have an identifier. In one example, the processor 208 may determine if the location, as determined by an identifier of the device location, corresponds to an identifier for one of the distinct office locations, distinct networks of an office location, or VPN on the list of locations of the enterprise. In some examples, the processor 208 may evaluate the operational data corresponding to the domain based on the location by calculating an average domain network latency per location, as discussed above with respect to FIG. 3.

As discussed above with respect to FIG. 1, operational data corresponding to the domain may include an application. The application may include an identifier, a vendor of the application, a name of the application, a list of computing devices with access rights, and a name of an enterprise with access rights, for example. In some examples, the processor 208 may identify an application of operational data corresponding to a domain by searching for one of the identifier, the vendor, or the name. As discussed above with respect to FIG. 3, identifying information of the enterprise may include a list of applications utilized by the enterprise. An application on the list of applications may include an identifier, a vendor of the application, a name of the application, a list of computing devices with access rights, and a name of an enterprise with access rights, for example. In one example, the processor 208 may determine if the application, as determined by the name, corresponds to a name on the list of applications. In some examples, the processor 208 may evaluate the operational data corresponding to the domain based on the application by calculating an average application performance, as discussed above with respect to FIG. 3.

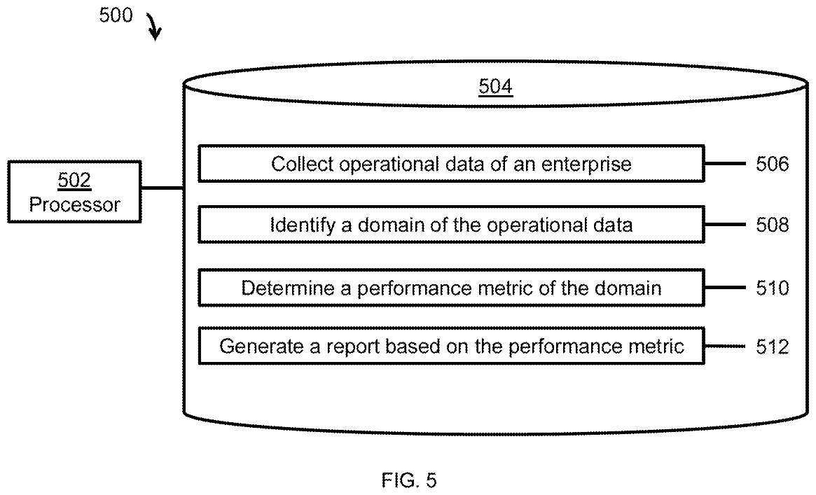

FIG. 5 depicts a schematic diagram of a system 500, in accordance with various examples. The system 500 comprises a computer-readable medium 504 and a processor 502 coupled to the computer-readable medium 504. The system 500 may be the processing environment 205, for example. The system 500 may be a computing device or a network of computing devices, as discussed above with respect to FIG. 2. The computer-readable medium 504 may be a storage device such as a hard drive, solid state drive (SSD), flash memory, random access memory (RAM), or other suitable memory, for example. The computer-readable medium 504 may be the storage device 210, for example. The computer-readable medium 504 may be local to the computing device or may be on a remotely-managed storage device (e.g., enterprise cloud, public cloud, data center, server, or some other suitable storage device), as discussed above with respect to FIG. 2. The processor 502 may be a microprocessor, a microcomputer, a microcontroller, or another suitable embedded processor or embedded controller, for example. The processor 502 may be the processor 208, for example. The processor 502 may be local to the computing device comprising the computer-readable medium 504 or may be on a remotely-managed computing device, as discussed above with respect to FIG. 2. The computer-readable medium 504 may store machine-readable instructions, which, when executed, cause the processor 502 to perform some or all of the actions attributed herein to the processor 502.

The computer-readable medium 504 comprises machine-readable instructions 506, 508, 510, and 512. The machine-readable instructions 506, 508, 510, 512 may be machine-readable instructions 212, for example. The machine-readable instructions 506, 508, 510, 512 may be machine-readable instructions for execution by the processor 502. Execution of the machine-readable instructions 506, 508, 510, 512 may cause the processor 502 to generate a report based on a performance metric corresponding to a domain. Execution of machine-readable instruction 506 may cause the processor 502 to collect operational data of an enterprise. Execution of machine-readable instruction 508 may cause the processor 502 to identify a domain of the operational data. Execution of machine-readable instruction 510 may cause the processor 502 to determine a performance metric of the domain. Execution of machine-readable instruction 512 may cause the processor 502 to generate a report based on the performance metric.

As discussed above with respect to FIG. 2, an enterprise owning the processing environment 205 may grant an enterprise to which the computing devices 202 belong access rights to the storage devices 209. The enterprise to which the computing devices 202 belong may grant the enterprise owning the processing environment 205 access rights to data of the computing devices 202 stored on the storage devices 209. The data of the computing devices 202 is considered operational data of the enterprise to which the computing devices belong. In one example, the processor 502 may collect operational data of the enterprise by accessing the data stored on the storage devices 209.

As discussed above with respect to FIG. 3, in some examples, the processor 502 may categorize, by domain, the operational data of the enterprise by aggregating operational data related to a domain into a data structure. The data structure may be stored on the computer-readable medium 504, for example. Each domain of the domains of the enterprise may have a stored data structure comprising aggregated operational data corresponding to a domain. As also discussed above with respect to FIG. 3, in various examples, the processor 502 determines a performance metric of each domain of the list of domains of the enterprise. The processor 502 may evaluate operational data corresponding to a domain on a routine basis (e.g., daily, weekly, monthly). The performance metrics may include an average domain network latency, an average application network latency, an average domain network latency per location, and an average application performance, for example. The processor 502 may generate a report based on the performance metric, as discussed above with respect to FIG. 3.

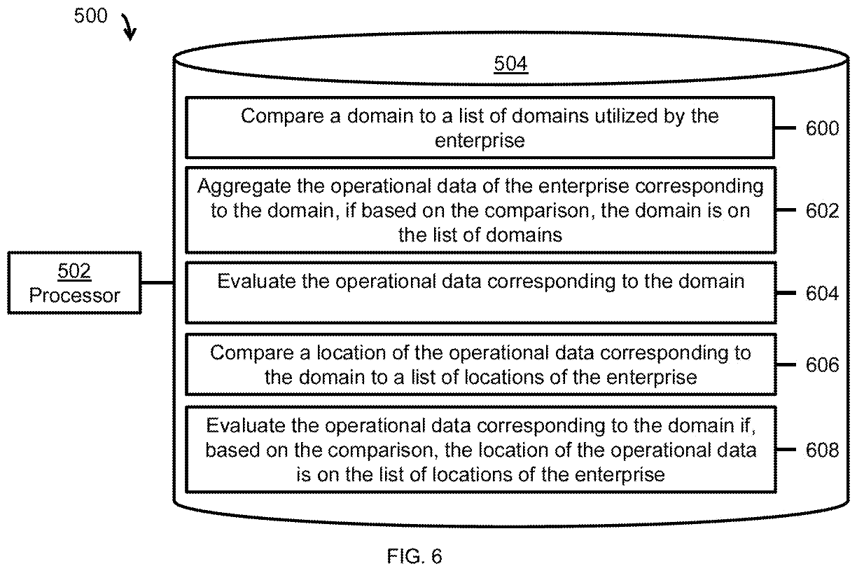

FIG. 6 depicts a schematic diagram of the system 500, in accordance with various examples. As discussed above with respect to FIG. 5, the system 500 comprises the computer-readable medium 504 and the processor 502 coupled to the computer-readable medium 504. The system 500 may be the processing environment 205, for example. The computer-readable medium 504 may be the storage device 210, for example. The processor 502 may be the processor 208, for example.

In some examples, the computer-readable medium 504 may comprise machine-readable instructions 600, 602, 604, 606, and 608. The machine-readable instructions 600, 602, 604, 606, 608 may be machine-readable instructions 212, for example. The machine-readable instructions 600, 602, 604, 606, 608 may be machine-readable instructions for execution by the processor 502. Execution of the machine-readable instructions 600, 602, 604, 606, 608 may cause the processor 502 to evaluate, based on a location, operational data of an enterprise that is aggregated based on a domain. Execution of machine-readable instruction 600 may cause the processor 502 to compare a domain to a list of domains utilized by the enterprise. Execution of machine-readable instruction 602 may cause the processor 502 to aggregate the operational data of the enterprise corresponding to the domain, if based on the comparison, the domain is on the list of domains. Execution of machine-readable instruction 604 may cause the processor 502 to evaluate the operational data corresponding to the domain. Execution of machine-readable instruction 606 may cause the processor 502 to compare a location of the operational data corresponding to the domain to a list of locations of the enterprise. Execution of machine-readable instruction 608 may cause the processor 502 to evaluate the operational data corresponding to the domain if, based on the comparison, the location of the operational data is on the list of locations of the enterprise.

In some examples, after identifying a domain of operational data of a computing device of an enterprise, the processor 502 may compare the domain to a list of domains utilized by the enterprise. As discussed above with respect to FIG. 3, the list of domains utilized by the enterprise may be a list of Internet domains. In some examples, the processor 502 may compare the domain to a list of intranet domains utilized by the enterprise. Based on the comparison indicating the domain is on the list of domains utilized by the enterprise, the processor 502 may categorize, by the domain, the operational data of the enterprise by aggregating operational data related to the domain into a data structure, as discussed above with respect to FIG. 3 and FIG. 5. The processor 502 evaluates the aggregated operational data corresponding to the domain to determine a performance metric.

In some examples, after identifying a location of the operational data corresponding to the domain, the processor 502 may compare the location to a list of locations utilized by the enterprise. As discussed above with respect to FIG. 4, the processor 502 may identify a location of operational data corresponding to a domain by searching for one of the identifier, the intranet domain, or the location of the device location stored in the operational data. The processor 502 may determine if the location, as determined by one of the identifier, the intranet domain, or the location of the device location, corresponds to an identifier, an intranet domain, or a location of one of the distinct office locations, distinct networks of an office location, or VPN on the list of locations of the enterprise. In some examples, based on the comparison indicating the location is on the list of locations, the processor 502 may aggregate operational data corresponding to the domain by the location. The processor 502 may evaluate the operational data corresponding to the domain by calculating an average domain network latency for the location. In various examples, the processor 502 may compare each location to the list of locations of the enterprise. Based on the comparison indicating the location is on the list of locations, the processor 502 may aggregate operation data corresponding to the domain by each location with a match. The processor 502 may calculate an average domain network latency for each location with a match.

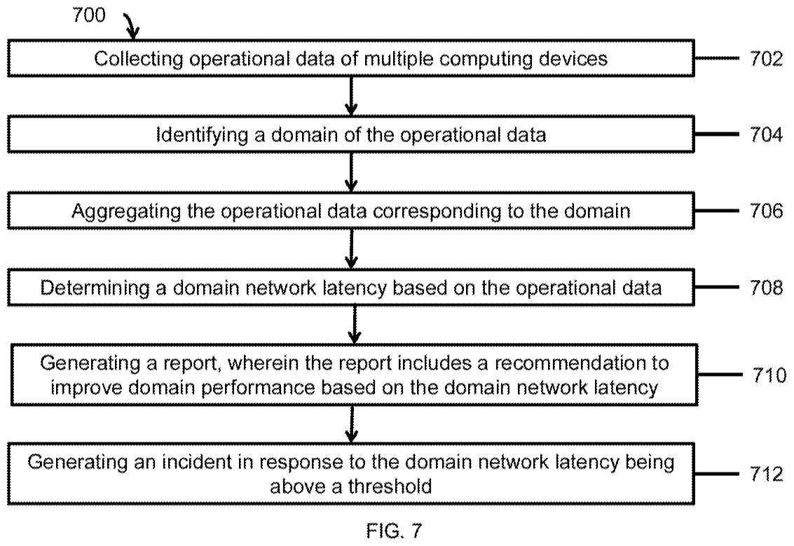

FIG. 7 depicts a flow diagram of a method 700, in accordance with various examples. The method 700 may be performed, for instance, by the processor 208, 502. The method 700 includes collecting operational data of multiple computing devices (702). The method 700 also includes identifying a domain of the operational data (704). In addition, the method 700 includes aggregating the operational data corresponding to the domain (706). Additionally, the method 700 includes determining a domain network latency based on the operational data (708). The method 700 also includes generating a report, where the report includes a recommendation to improve domain performance based on the domain network latency (710). In addition, the method 700 includes generating an incident in response to the domain network latency being above a threshold (712).

As discussed above with respect to FIG. 2, in various examples, a first computing device 204 of multiple computing devices 202 may belong to a first enterprise, while a second computing device of the multiple computing devices 202 may belong to a second enterprise. An enterprise owning the processing environment 205 may grant the first enterprise and the second enterprise access rights to the storage devices 209. The first enterprise may grant the enterprise owning the processing environment 205 access rights to data of the first computing device 204 stored on the storage devices 209. The second enterprise may grant the enterprise owning the processing environment 205 access rights to data of the second computing device stored on the storage devices 209. The processor 208 may collect operational data of the first computing device 204 and the second computing device.

In some examples, the processor 208, 502 may identify a domain of the operational data by searching operational data for a domain name. As discussed above with respect to FIG. 3 and FIG. 5, the processor 208, 502 may categorize, by domain, the operational data by aggregating operational data related to a domain into a data structure. In various examples, the processor 208, 502 may determine a domain network latency for each domain of the operational data by calculating an average network latency for the domain utilizing a domain measurement, such as network latency of the domain, of the operational data corresponding to the domain.

In various examples, the processor 208, 502 may generate a report that includes a recommendation for improving the performance of the domain based on the domain network latency. In one example, the processor 208, 502 may analyze the operational data corresponding to the domain by an enterprise of the operational data. The analysis may demonstrate that the domain network latency for a first enterprise and a second enterprise are equivalent. Since the equivalence may imply that a network of the first enterprise and a network of the second enterprise interact with the domain in the same manner, the processor 208, 502 may recommend replacing a server of the domain to decrease network latency. In another example, the analysis may demonstrate that the domain network latency for the first enterprise is significantly higher than the domain network latency for the second enterprise. Since the domain network latency for the first enterprise is significantly higher, the processor 208, 502 may recommend replacing a network component of the first enterprise to decrease latency of the network. In some examples, after comparing the domain network latency of the first enterprise to the domain network latency of the second enterprise or the domain network latency of an industry of the first enterprise, the processor 208, 502 may determine the domain network latency of the first enterprise is significantly higher than a norm of the domain or a norm of the domain for the industry. The norm of the domain or the norm of the domain for the industry may be considered a threshold. The processor 208, 502 may generate an incident. The incident indicates the significant deviation above the threshold.

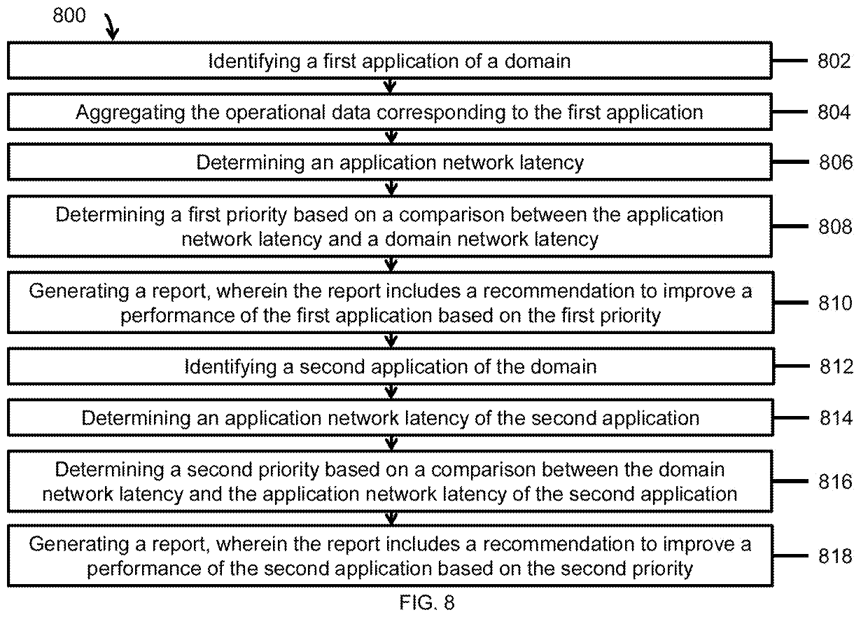

FIG. 8 depicts a flow diagram of a method 800, in accordance with various examples. The method 800 may be performed, for instance, by the processor 208, 502. The method 800 includes identifying a first application of a domain (802). The method 800 also includes aggregating the operational data corresponding to the first application (804). In addition, the method 800 includes determining an application network latency (806). Additionally, the method 800 includes determining a first priority based on a comparison between the application network latency and a domain network latency (808). The method 800 also includes generating a report, where the report includes a recommendation to improve a performance of the first application based on the first priority (810). In addition, the method 800 includes identifying a second application of the domain (812). Additionally, the method 800 includes determining an application network latency of the second application (814). The method 800 also includes determining a second priority based on a comparison between the domain network latency and the application network latency of the second application (816). In addition, the method 800 includes generating a report, where the report includes a recommendation to improve a performance of the second application based on the second priority (818).

As discussed above with respect to FIG. 1 and FIG. 4, operational data corresponding to the domain may include an application. The application may include an identifier, a vendor of the application, a name of the application, a list of computing devices with access rights, and a name of an enterprise with access rights, for example. In some examples, the processor 208, 502 may identify a first application of operational data corresponding to a domain by searching for one of the identifier, the vendor, or the name. The processor 208, 502 may aggregate, by the first application, operational data corresponding to the domain into a data structure. The processor 208, 502 may evaluate the operational data corresponding to the domain based on the application by calculating an application network latency. In various examples, the processor 208, 502 may determine an application network latency for the first application by calculating an average network latency for the application utilizing a domain measurement, such as network latency of the endpoint, of the operational data corresponding to the domain. The processor 208, 502 may compare the application network latency to the domain network latency, as discussed above with regard to FIG. 7. Based on the comparison, the processor 208, 502 may determine a first priority. The first priority indicates the application network latency is significantly higher than the domain network latency. If the processor 208, 502 determines the application network latency has a first priority, then the processor 208, 502 may generate a report that includes a recommendation to improve a performance of the first application. For example, the processor 208, 502 may recommend a server hosting the first application is replaced.

As discussed above with respect to the first application of the domain, the processor 208, 502 may identify a second application of the domain, determine an application network latency of the second application, and determine a second priority. The second priority indicates the application network latency of the second application is significantly higher than the domain network latency. If the processor 208, 502 determines the application network latency of the second application has a second priority, then the processor 208, 502 may generate a report that includes a recommendation to improve a performance of the second application. For example, the processor 208, 502 may recommend a server hosting the second application is replaced. In another example, if the processor 208, 502 determines the first application has a first priority and the second application has a second priority, the processor 208, 502 may determine if the first application and the second application are hosted on different servers. Based on the determination that the first application and the second application are hosted on different servers, the processor 208, 502 may recommend a server hosting the domain be replaced.

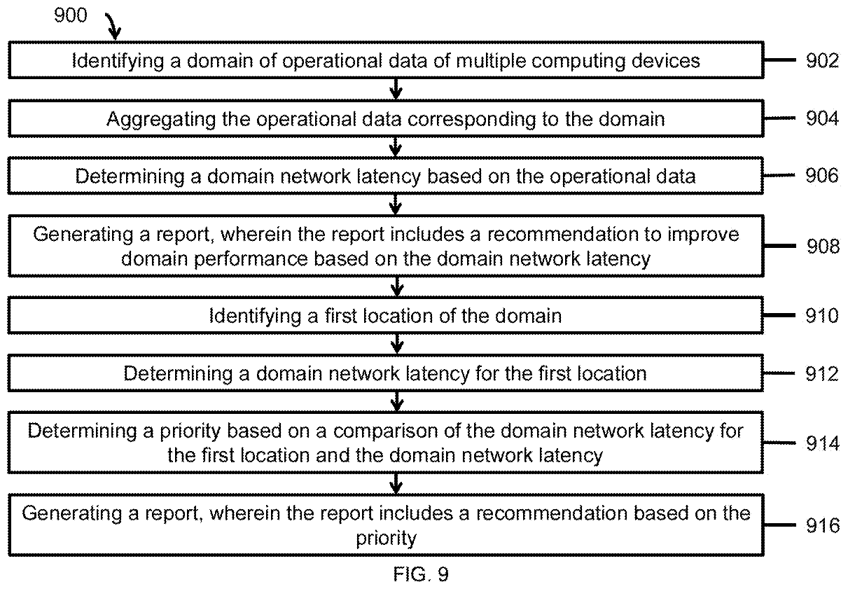

FIG. 9 depicts a flow diagram of a method 900, in accordance with various examples. The method 900 may be performed, for instance, by the processor 208, 502. The method 900 includes identifying a domain of operational data of multiple computing devices (902). The method 900 also includes aggregating the operational data corresponding to the domain (904). In addition, the method 900 includes determining a domain network latency based on the operational data (906). Additionally, the method 900 includes generating a report, where the report includes a recommendation to improve domain performance based on the domain network latency (908). The method 900 also includes identifying a first location of the domain (910). In addition, the method 900 includes determining a domain network latency for the first location (912). Additionally, the method 900 includes determining a priority based on a comparison of the domain network latency for the first location and the domain network latency (914). The method 900 also includes generating a report, where the report includes a recommendation based on the priority (916).

As discussed above with respect to FIG. 7, in various examples, the processor 208, 502 may identify a domain of the operational data by searching operational data for a domain name. As discussed above with respect to FIG. 3, FIG. 5, and FIG. 7, the processor 208, 502 may categorize, by domain, the operational data by aggregating operational data related to a domain into a data structure. In some examples, the processor 208, 502 may determine a domain network latency by calculating an average network latency for the domain utilizing a domain measurement, such as network latency of the domain, of the operational data corresponding to the domain. In various examples, the processor 208, 502 may aggregate the operational data corresponding to a domain by an enterprise. The processor 208, 502 may determine a domain network latency for the enterprise. The processor 208, 502 may aggregate the operational data corresponding to a domain by each enterprise in the operational data. The processor 208, 502 may determine a domain network latency for each enterprise. In some examples, the processor 208, 502 may compare the domain network latency to the domain network latency for each enterprise. Based on the comparison, the processor 208, 502 may provide a recommendation to improve domain performance. For example, the processor 208, 502 may determine that a network component utilized by multiple enterprises is overburdened and suggest upgrading the network component.

In various examples, the processor 208, 502 may determine a first location of the domain. (See discussion above with respect to FIG. 3, FIG. 4, and FIG. 6 for examples.) In some examples, the processor 208, 502 may determine a domain network latency for the first location by calculating an average network latency for the domain utilizing a domain measurement, such as network latency of the domain, of the operational data corresponding to the domain. The processor 208, 502 may determine a priority based on a comparison of the domain network latency for the first location and the domain network latency. The priority indicates the domain network latency for the first location is significantly higher than the domain network latency. If the processor 208, 502 determines the domain network latency of the first location has a priority, then the processor 208, 502 may generate a report that includes a recommendation to improve a performance of the first location. For example, the processor 208, 502 may recommend an additional network component be added to a network of the first location to distribute the transmission from multiple computing devices of the first location.

The above discussion is meant to be illustrative of the principles and various examples of the present disclosure. Numerous variations and modifications will become apparent to those skilled in the art once the above disclosure is fully appreciated. It is intended that the following claims be interpreted to embrace all such variations and modifications.

In the figures, certain features and components disclosed herein may be shown exaggerated in scale or in somewhat schematic form, and some details of certain elements may not be shown in the interest of clarity and conciseness. In some of the figures, in order to improve clarity and conciseness, a component or an aspect of a component may be omitted.

In the above discussion and in the claims, the terms “including” and “comprising” are used in an open-ended fashion, and thus should be interpreted to mean “including, but not limited to . . . .” Also, the term “couple” or “couples” is intended to be broad enough to encompass both indirect and direct connections. Thus, if a first device couples to a second device, that connection may be through a direct connection or through an indirect connection via other devices, components, and connections. As used herein, including in the claims, the word “or” is used in an inclusive manner. For example, “A or B” means any of the following: “A” alone, “B” alone, or both “A” and “B.” In addition, when used herein including the claims, the word “generally” or “substantially” means within a range of plus or minus 10% of the stated value.

What is claimed is:

1. A non-transitory computer-readable medium storing machine-readable instructions which, when executed by a processor, cause the processor to:
collect operational data of an enterprise;
identify a domain of the operational data;
determine a performance metric of the domain; and
generate a report based on the performance metric.

2. The computer-readable medium of claim 1, wherein execution of the machine-readable instructions causes the processor to compare the domain to a list of domains utilized by the enterprise.

3. The computer-readable medium of claim 2, wherein execution of the machine-readable instructions causes the processor to:
aggregate the operational data of the enterprise corresponding to the domain if, based on the comparison, the domain is on the list of domains; and
evaluate the operational data corresponding to the domain.

4. The computer-readable medium of claim 3, wherein execution of the machine-readable instructions causes the processor to compare a location of the operational data corresponding to the domain to a list of locations of the enterprise.

5. The computer-readable storage of medium 4, wherein execution of the machine-readable instructions causes the processor to evaluate the operational data corresponding to the domain if, based on the comparison, the location of the operational data is on the list of locations of the enterprise.

6. A system comprising:
a network interface;
a storage device comprising machine-readable instructions; and
a processor coupled to the network interface, the processor to access the storage device, wherein execution of the machine-readable instructions causes the processor to:
collect operational data of an enterprise;
collect operational data of multiple computing devices of the enterprise;
identify a domain of the operational data of the enterprise;
categorize, by the domain, the operational data of the multiple computing devices;
evaluate the operational data corresponding to the domain; and
generate a report based on the evaluation.

7. The system of claim 6, wherein operational data of a computing device of the multiple computing devices comprises an identifier, a location, an enterprise, an application, a domain history, a domain measurement, or a combination thereof.

8. The system of claim 7, wherein the operational data of the enterprise comprises a list of applications, a list of domains, a list of applications per domain, a list of locations, or a combination thereof.

9. The system of claim 8, wherein execution of the machine-readable instructions causes the processor to:
identify a location of the operational data corresponding to the domain; and
evaluate the operational data corresponding to the domain based on the location, if the location is on the list of locations.

10. The system of claim 9, wherein execution of the machine-readable instructions causes the processor to:
identify an application of the operational data corresponding to the domain; and
evaluate the operational data corresponding to the domain based on the application, if the application is on the list of applications.

11. A method comprising:
collecting operational data of multiple computing devices;
identifying a domain of the operational data;
aggregating the operational data corresponding to the domain;
determining a domain network latency based on the operational data; and
generating a report, wherein the report includes a recommendation to improve domain performance based on the domain network latency.

12. The method of claim 11, comprising:
identifying a first application of the domain;
aggregating the operational data corresponding to the first application;
determining an application network latency;
determining a first priority based on a comparison between the application network latency and the domain network latency; and
generating a report, wherein the report includes a recommendation to improve a performance of the first application based on the first priority.

13. The method of claim 12, comprising:
identifying a second application of the domain;
determining an application network latency of the second application;
determining a second priority based on a comparison between the domain network latency and the application network latency of the second application; and
generating a report, wherein the report includes a recommendation to improve a performance of the second application based on the second priority.

14. The method of claim 11, comprising:
identifying a first location of the domain;
determining a domain network latency for the first location;
determining a priority based on a comparison of the domain network latency for the first location and the domain network latency; and
generating a report, wherein the report includes a recommendation based on the priority.

15. The method of claim 11, comprising generating an incident in response to the domain network latency being above a threshold.
